(19) United States
(12) Patent Application Publication
(10) Pub. No.: US 2022/0361700 A1
(43) Pub. Date: Nov. 17, 2022

(54) PARCEL CHUTE FOR AN OUTER WALL OF A BUILDING OR AN ENCLOSURE OF A BALCONY, METHOD FOR DELIVERING A PARCEL USING AN UNMANNED AIRCRAFT AND FOR GUIDING THE PARCEL THROUGH A PARCEL CHUTE, OUTER WALL OF A BUILDING AND ENCLOSURE FOR A BALCONY OF A BUILDING

(71) Applicant: Schöck Bauteile GmbH, Baden-Baden (DE)

(72) Inventors: Gunther REINHARD, Konigsbach (DE); Hubert FRITSCHI, Baden-Baden (DE)

(73) Assignee: Schöck Bauteile GmbH, Baden-Baden (DE)

(21) Appl. No.: 17/740,978

(22) Filed: May 10, 2022

(30) Foreign Application Priority Data
May 11, 2021 (DE) 102021112296.1

(51) Int. Cl. A47G 29/30; A47G 29/14; B64C 39/02

(52) U.S. Cl. CPC A47G 29/30; A47G 29/141; B64C 39/024; B64C 2201/128

(57) ABSTRACT

A parcel chute (1) is provided for an outer wall (13) of a building or an enclosure of a balcony which is used for the automatic delivery and collection of a parcel (2) by an unmanned aircraft, in particular a logistics drone. A method for delivering a parcel (2) using an unmanned aircraft, in particular a logistics drone, an outer wall (13) with a parcel chute (1), and an enclosure with a parcel chute (1) are also provided.

### INCORPORATION BY REFERENCE

The following documents are incorporated herein by reference as if fully set forth: German Patent Application No. 10 2021 112 296.1, filed May 11, 2021.

### TECHNICAL FIELD

The present invention relates to a parcel chute for an outer wall of a building or an enclosure of a balcony which is used for the automatic delivery and collection of a parcel by means of an unmanned aircraft, in particular a logistics drone, and to a method for delivering a parcel using an unmanned aircraft and for guiding the parcel through this parcel chute. The present invention further relates to an outer wall of a building and an enclosure for a balcony of a building which each comprise a parcel chute of this kind.

### BACKGROUND

Today parcels are either delivered in person to a recipient or temporarily stored in parcel depots set up in public spaces until the recipient collects the parcel from the parcel depot. Prior to this, a parcel content which is to be dispatched in the parcel is packed in the parcel in a logistics center or by a sender and transported to the recipient or the parcel depot by means of a manned delivery vehicle. This kind of parcel delivery is highly labor-intensive, and therefore cost-intensive, and in most cases it requires the recipient to be present or there to be a parcel depot in the immediate vicinity of the recipient during the parcel delivery. In addition, the delivery time is restricted to certain times of day.

In order to overcome these disadvantages and to cope with the increasing number of parcels that have to be delivered due to the growth in online business, a further development of this parcel delivery envisages the use of unmanned aircraft, in particular logistics drones, which collect the parcels to be delivered from the logistics center, or also from a lorry, and deposit them at a drop-off location specified by the recipient which may be designed as a parcel drop-off platform, for example, on which the logistics drone is able to drop off the parcel, or as a parcel container which can receive the delivered parcel. Both the parcel drop-off platform and the parcel container can be set up on the recipient's property. By way of example, WO 2016/094067 A1 discloses a parcel container with a container interior which is used for receiving a parcel, and a communication unit which is used for communication between the logistics drone delivering the parcel and the parcel container. Using an unmanned logistics drone combined with a parcel container of this kind means that delivery staff can be dispensed with. However, there are disadvantages associated with this parcel container, in that (a) the recipient has to fetch the parcel from the container interior and carry it into their house or flat, (b) the parcel container can be broken into and the parcel located in the container interior thereof stolen, and (c) the parcel content can be damaged or destroyed due to the environmental conditions.

In addition, the number of parcels that can be accepted at the recipient's end is limited to the volume of the container interior. If the number and size of the parcels being delivered exceeds the volume of the container interior, it is not possible for all parcels to be delivered. The three disadvantages referred to above are particularly important when the recipient is away from home and the parcel cannot therefore be collected from the container interior for a prolonged period. To the extent that the recipient of the parcel does not live in a single-family house, but in a multi-family dwelling, there must also be multiple parcel containers of this kind set up on the property of the multi-family dwelling, which leads to space issues when installing the parcel containers, particularly in urban areas where plot sizes are small.

### SUMMARY

The objective addressed by the present invention is therefore that of specifying a parcel chute for an outer wall of a building or an enclosure of a balcony, a method for delivering a parcel using an unmanned aircraft and for guiding the parcel through a parcel chute, an outer wall of a building and an enclosure for a balcony of a building, which facilitate a simplified delivery of an unlimited number of parcels by an unmanned aircraft straight into a living or balcony area of the recipient and the safe-keeping of the parcel contents, even when the recipient is absent.

This objective is solved by a parcel chute for an outer wall of a building or an enclosure of a balcony, a method for delivering a parcel using an unmanned aircraft and for guiding the parcel through a parcel chute, an outer wall of a building, and an enclosure for a balcony of a building, each having one or more features of the invention as specified herein. Advantageous embodiments and developments of the invention are described below and in the claims.

A parcel chute of the kind referred to above is used for the automatic delivery and collection of a parcel by means of an unmanned aircraft, in particular a logistics drone, and comprises, according to the invention, a base body with at least one opening for the parcel, a first side for the delivery and collection of the parcel, and a second side opposite the first side for storing the parcel. In other words, the base body has two sides lying opposite one another; the first side is used for the delivery and collection of the parcel and the second side for storing the parcel following delivery or prior to collection.

Furthermore, the parcel chute has a chute door which substantially completely closes the opening in a closed state and opens it up in its opened state, in order to guide the parcel through the opening. This chute door is preferably arranged on the first side or the second side of the base body, at least in its opened state. So that a delivered parcel can be dropped off by the unmanned aircraft or a parcel for collection can be received by the unmanned aircraft, the parcel chute according to the invention also has a parcel drop-off area which is arranged on the first side of the base body, at least when the chute door is in the opened state. The wording “at least when the chute door is in the opened state” means in this context that the parcel drop-off area is either arranged on the first side, so on the side of the base body for delivery and collection of the parcels, only when the chute door is in the opened state, or when the chute door is in both the opened state and the closed state.

In order to move the chute door from the closed state into the opened state, and in the opposite direction, the parcel chute further comprises a drive. This drive interacts with the movable chute door in such a manner that it moves the chute door from the closed state into the opened state, and in the opposite direction, and therefore opens up or closes the opening so that parcels can be guided through.

The unmanned aircraft can obtain the recipient's address details from the logistics center, so that it can fly from the logistics center to the recipient's location. So that the unmanned aircraft also knows the precise location details of the parcel chute within the outer wall or the balcony enclosure, the parcel chute according to the invention has a communication unit which is designed to communicate contactlessly with the unmanned aircraft during the delivery or collection of the parcel. In the context of this communication between the communication unit of the parcel chute and the unmanned aircraft, GPS data, data on the relative height or similar of the parcel chute, for example, are transmitted to the unmanned aircraft and information on the parcel delivery or collection which is taking place is exchanged in the form of a digital delivery or handover message. This information includes, for example, the parcel size, name of the parcel sender, the parcel content, the storage conditions thereof and/or the number of parcels. The communication unit is, in addition, connected to the drive of the parcel chute in an information-conveying manner, as a result of which the chute door can be moved from the closed state into the opened state, and in the opposite direction, during the delivery or collection of the parcel. This communication unit may have a transmitter for positional data of the parcel chute and/or a receiver for positional data of the unmanned aircraft and/or data relating to the parcel.

The parcel chute may be integrated into the outer wall of a building or into the enclosure, in particular a balcony balustrade or a balcony railing, of a balcony in such a manner that its base body crosses the outer wall of the building or a vertically standing enclosure element of the balcony, in particular a balcony railing or a balcony balustrade, so that a parcel delivered by the unmanned aircraft can be guided through the opening from the first side to the second side of the base body and thereby stored in a building or balcony interior, until the recipient takes delivery of the parcel and unpacks it, where appropriate. Depending on whether the parcel chute is integrated in the outer wall of the building or in the enclosure, in particular the balcony balustrade or the balcony railing, the first side of the base body is located on an outer side of the wall oriented towards an outer side of the building or on an enclosure outer side of the enclosure element. The second side of the base body is arranged on a wall inner side oriented towards an inner side of the building or on an enclosure inner side of the enclosure element oriented towards a building inner side. As already mentioned previously, the parcel drop-off area is arranged on the first side of the base body only when the chute door is in the opened state, or in the opened and closed state. The parcel can be dropped off onto it by the unmanned aircraft or the parcel can be retrieved from it by the unmanned aircraft.

If letter boxes from the prior art made of metal or a metal alloy are fitted in an outer wall of a building, a heat bridge is created in the region of the letter box, as a result of which heat is emitted from a building interior to the surroundings of the building. A greater energy requirement is needed when heating the building interior, in order to compensate for this heat loss. In order to avoid the formation of a heat bridge of this kind in the case of the present parcel chute, and to reduce the energy requirement when heating the building, an advantageous embodiment of the parcel chute according to the invention envisages that the chute door is designed at least partly from a heat-insulating material. For example, the chute door may have a layer structure with at least one core layer which is designed at least partly from the heat-insulating material, and at least two outer layers delimiting the core layer on one side in each case. These outer layers preferably form the two outer sides of the chute door. The core layer may be designed from individual heat insulation panels which are adjacent to one another, or from a heat-insulating material in the form of bulk material, which is added between the outer layers. The heat-insulating material may be polystyrene, for example, in particular expanded polystyrene, mineral wool, polyurethane, or an aerogel with a silicate base, in particular. In order to reduce the heat conductivity of this aerogel, the aerogel can be surrounded by a vacuum-sealed film and an air fraction contained in the aerogel can be removed through evacuation forming a vacuum-insulating panel. The outer layers may be formed from metal, a metal alloy or plastic. The chute door, in particular the core layer thereof, may also comprise the drive and/or the communication unit alongside the heat-insulating material. In this case, the core layer therefore comprises the heat-insulating material and also the drive and/or the communication unit.

A further aspect of the invention envisages a method for delivering a parcel using an unmanned aircraft, in particular a logistics drone, and for guiding said parcel through a parcel chute. The parcel chute may be integrated in an outer wall of a building or in an enclosure of a balcony, in particular a balcony balustrade or a balcony railing. In the former case, the method is preferably a method for delivering a parcel using an unmanned aircraft, in particular a logistics drone, and for guiding said parcel through a parcel chute of an outer wall. In the latter case, the method is preferably a method for delivering the parcel using an unmanned aircraft, in particular a logistics drone, and for guiding said parcel through a parcel chute of a balcony balustrade.

In accordance with the inventive method, an unmanned aircraft, in particular a logistics drone, flies in a method step (a) to a parcel chute, wherein the unmanned aircraft is loaded with a parcel, and in a method step (b) it transmits a digital delivery instruction to a communication unit of the parcel chute. In this way, the parcel chute is notified that the delivery of a parcel is imminent. In a method step (c) the parcel chute then transmits its positional data to the unmanned aircraft through the communication unit, for example in the form of GPS data, data on its relative height, data on the clear chute door identification, or the like, as a result of which the unmanned aircraft knows the precise position of the parcel chute. The term “precise position” means in this context that the unmanned aircraft is able to set a course for the parcel drop-off area and deliver the parcel there without crashing in the process, for example. This enables parcels to be delivered not only to single-family dwellings, but also to flats in multi-family dwellings and to offices in multi-story office buildings. In a next step (d), a chute door of the parcel chute is moved from a closed state into an opened state by a drive of the parcel chute, as a result of which an opening in a base body of the parcel chute is opened up to guide the parcel through the opening. Either following this method step (d) or at the same time as this method step (d), in a method step (e) the unmanned aircraft sets a course for a parcel drop-off area of the parcel chute arranged on a first side of the base body with the help of the positional data provided. The drop-off of the parcel on the parcel drop-off area by the unmanned aircraft then follows in a method step (f). Once the parcel has been dropped off by the unmanned aircraft, said parcel is guided from the first side of the base body through the opening to a second side of the base body in a method step (g). Depending on whether the parcel chute is an integral part of an outer wall or a balcony enclosure, the parcel is guided or transported in a method step (g) into a building interior or a balcony interior, which lie on the second side of the base body of the parcel chute. Once the parcel has been delivered and guided through the parcel chute, the chute door of the parcel chute is moved in a method step (h) from the opened state into the closed state by the driving means of the parcel chute, as a result of which the opening in the base body of the parcel chute is closed again.

Apart from the delivery of parcels, parcels can also be collected by the unmanned aircraft. For this purpose, the unmanned aircraft, in particular the logistics drone, flies to the parcel chute, whereupon the aircraft is still unladen, and transmits a digital collection message to the communication unit of the parcel chute. As a result of this, the parcel chute is aware that a parcel collection is imminent. The parcel chute then transmits its positional data through the communication unit to the unmanned aircraft, as a result of which the unmanned aircraft knows the precise position of the parcel chute. This enables parcels to be collected not only from single-family dwellings, but also from flats in multi-family dwellings and offices in multi-story office buildings. In a next step, the chute door of the parcel chute is moved from the closed state into the opened state by the drive of the parcel chute, as a result of which the opening in the base body of the parcel chute is opened up to allow the parcel to be guided through the opening. Once the opening in the base body of the parcel chute is opened up to allow the parcel to be guided through the opening, said parcel is guided from the second side of the base body through the opening to the first side of the base body. Depending on whether the parcel chute is an integral part of an outer wall or a balcony enclosure, the parcel is guided or transported in this method step from a building interior or a balcony interior to a building exterior or a balcony exterior. Either following this method step or at the same time as this method step, the unmanned aircraft sets course for the parcel drop-off area of the parcel chute arranged on the first side of the base body with the help of the positional data conveyed. The parcel is then picked up from the parcel drop-off area by the unmanned aircraft and the unmanned aircraft flies along with the parcel to a logistics center or straight to a recipient. Once the parcel has been collected, the chute door of the parcel chute is moved from the opened state into the closed state by the drive of the parcel chute, as a result of which the opening in the base body of the parcel chute is closed again.

In an advantageous embodiment of the parcel chute according to the invention, said parcel chute comprises a receiving element for the parcel arranged on the second side of the base body. Once the parcel has been guided from the first side of the base body through the opening to the second side of the base body, the parcel can be received by this receiving element and stored until it is retrieved by the recipient. This receiving element is preferably a collection net, a box, in particular a thermo-box, or a refrigerator. In an advantageous development of the method according to the invention, the parcel is received by said parcel receiving element of the parcel chute arranged on the second side of the base body following method step (g), which parcel receiving element is preferably a collection net, a box, in particular a thermo-box, or a refrigerator. Insofar as the receiving element is designed as a thermo-box or refrigerator, food delivered in the parcel can be stored in a cold or warm environment and protected from spoiling. This receiving element may either be attached directly to the opening on the second side of the base body or connected via an automatic feed system.

So that the delivered or collected parcel can be automatically guided through the opening, the parcel drop-off area may have a conveying element, in particular a conveyor belt, which is designed to transport the parcel from the first to the second side of the base body, or in the opposite direction. In a further advantageous development of the method according to the invention, the parcel is conveyed by this conveying element in method step (g) from the first side of the base body through the opening to the second side of the base body, preferably into the parcel receiving element.

The unmanned aircraft may be battery-powered. Since the rechargeable battery cells currently available on the market only allow the unmanned aircraft to have a small flying range, a further advantageous embodiment of the parcel chute according to the invention envisages that the parcel drop-off area has a charging device for the electrical charging of rechargeable battery cells of the unmanned aircraft. In a further advantageous development of the method according to the invention, the rechargeable battery cells of the unmanned aircraft are electrically charged during, or after, the method step (f) by a charging device of the parcel drop-off area. This electrical charging may take place in a contactless, in other words inductive, manner, as a result of which electrical energy is transmitted in a contactless manner from the charging device to the rechargeable battery cells of the unmanned aircraft. This allows rapid charging of the rechargeable battery cells of the unmanned aircraft, as a result of which the unmanned aircraft can also make long flights between the recipient and the logistics center.

In order to guarantee sufficient stability of the parcel chute in its installed state in the outer wall of the building or the enclosure of the balcony, a further advantageous embodiment of the parcel chute according to the invention envisages that the base body is designed as a frame which has two vertical legs arranged spaced apart from one another and two horizontal legs arranged spaced apart from one another, wherein the vertical legs and the horizontal legs substantially enclose the opening. The base body designed as a frame is preferably substantially rectangular in design. So that when the parcel chute is installed in an outer wall, the base body can cross this outer wall from its inner wall side to its outer wall side, a frame depth T of the base body may substantially correspond to a wall thickness D of the outer wall. If the outer wall has a wall thickness D, measured from its wall inner side to its wall outer side, of 37 cm, for example, the base body may likewise have a frame depth T of 37 cm. However, it is also within the framework of the invention that the frame depth T of the base body may be greater than the wall thickness D of the outer wall. In this case, the base body projects on both sides, i.e. beyond the wall inner side in the direction of the building interior and the wall outer side in the direction of a building surroundings. When the parcel chute is installed in the outer wall, at least one power transmission element may be fixed to the vertical legs and/or the horizontal legs on its side facing away from the opening in the base body, which power transmission element enables the base body designed as a frame to be anchored in the outer wall. This force transmission element may be a rod-shaped reinforcing element made of concrete reinforcing steel, high-grade steel or glass-fiber reinforced plastic, for example.

A further advantageous embodiment of the parcel chute according to the invention envisages that the chute door is an at least one-piece sliding door, which is arranged on the base body in a sliding manner and can be slid for movement into the closed state in front of the opening and in the opposite direction. The slidable chute door may—as already mentioned previously—be arranged on the first side or the second side of the base body. The base body may have at least one guide rail along which the sliding door can be slid to move the parcel chute into the closed state in front of the opening and to move the parcel chute into the opened state away from the opening. Insofar as the base body is designed as a frame, the guide rail may be arranged on a side of a first horizontal leg facing away from the opening, wherein this first horizontal leg corresponds to the lower horizontal leg of the frame when the parcel chute is in the installed state.

As an alternative to this, in a further advantageous embodiment of the parcel chute according to the invention, the chute door is a pivotable flap, which is arranged on the base body of the parcel chute so as to be pivotable about an axis. The pivotable flap is preferably arranged on the base body so as to be pivotable about the axis in the direction of the first side of said base body, wherein when the chute door is in the closed state the parcel drop-off area is arranged on a side of the flap facing the opening. The flap can preferably be pivoted about 90° about the axis, in order to move the chute door from its closed state into its opened state. If the chute door is arranged on the first side of the base body, it is oriented substantially vertically to the wall outer side or to a vertically standing enclosure element, when the parcel chute is in the installed state after pivoting 90° about the axis. In this case, the parcel drop-off area is therefore arranged on an upper side of the flap, so that the parcel can be dropped off by the unmanned aircraft on the parcel drop-off area arranged on the upper side of the flap or can be received by the parcel drop-off area arranged on the upper side of the flap.

Furthermore, the parcel chute may have a drawer designed in at least one piece, which can be extended in the direction of the first side of the base body, wherein the parcel drop-off area is arranged on a side of the drawer facing the opening. Also in this case, the parcel drop-off area is therefore arranged on an upper side of the drawer so that the parcel can be dropped off by the unmanned aircraft on the parcel drop-off area arranged on the upper side of the drawer or can be received by the parcel drop-off area arranged on the upper side of the drawer. This drawer may be provided, in particular, when the chute door is a sliding door and cannot therefore have a parcel drop-off area. Insofar as the base body is designed as a frame, the drawer may be arranged on a side of the first horizontal leg facing away from the opening. So that the drawer can be kept in its non-extended or non-pulled-out state and in the installed state of the parcel chute between the wall inner side and the wall outer side, the parcel chute may comprise a parcel receiving element which is preferably arranged on a side of the first horizontal leg of the base body facing away from the opening.

It may furthermore be provided that the drawer has a greater size in its extended state than the first horizontal leg of the base body designed as a frame, and can therefore be kept in its non-extended or non-pulled-out state in the parcel receiving element previously referred to. In order to realize this, a further advantageous embodiment of the parcel chute according to the invention envisages that a drawer base of the drawer has a multipart design, so that the drawer can be extended telescopically in the direction of the first side of the base body. This drawer base preferably includes the parcel drop-off area.

In order to simplify the structure of the chute door, in a further advantageous embodiment of the parcel chute according to the invention, said chute door is a drawer end wall of the drawer. This drawer end wall is arranged substantially perpendicularly to the drawer base on a side of the drawer facing away from the opening, wherein the drawer end wall completely closes the opening in the closed state of the chute door. This means that an additional chute door in the form of a pivotable flap or a sliding door can be dispensed with.

A third aspect of the invention relates to an outer wall of a building. According to the invention, this outer wall comprises a wall inner side oriented to a building inner side, a wall outer side oriented to a building outer side, a wall body, wall insulation and a parcel chute having one or more of the features described herein. In the case of this outer wall, a base body with at least one opening of the parcel chute crosses the outer wall from the wall inner side to the wall outer side. The previously described first side of the base body is arranged on the wall outer side of the outer wall of the body and the second side of the base body of the wall inner side. The wall body may, for example, be built from bricks, formed from a precast concrete part, or produced in a lightweight construction. The wall insulation may also be integrated in an inner area of the wall body.

A fourth aspect of the invention relates to an enclosure, in particular a balustrade or a railing, for a balcony of a building. This enclosure comprises at least one vertically standing enclosure element, an enclosure inner side of the enclosure element facing a building side, an enclosure outer side of the enclosure element opposite the enclosure inner side and a parcel chute having one or more of the features described herein, wherein a base body with at least one opening in the parcel chute crosses the vertically standing enclosure element from the enclosure outer side to the enclosure inner side. The vertically standing enclosure element may be a brick-built balustrade part, a balustrade part produced in a lightweight construction or a railing element made of metal, a metal alloy or plastic.

### BRIEF DESCRIPTION OF THE DRAWINGS

Further features or advantages of the present invention result from the following description of exemplary embodiments with the help of the drawings. In the drawing

FIG. 1 shows a first exemplary embodiment of a parcel chute according to the invention as a perspective representation from the front

FIG. 2 shows the first exemplary embodiment of the parcel chute according to the invention in side view

FIG. 3 shows a second exemplary embodiment of a parcel chute according to the invention in side view

FIG. 4 shows a third exemplary embodiment of a parcel chute according to the invention as a perspective representation from the front

FIG. 5 shows the third exemplary embodiment of the parcel chute according to the invention as a side view

FIG. 6 shows a fourth exemplary embodiment of a parcel chute according to the invention as a perspective representation from the front;

FIG. 7 shows a first exemplary embodiment of an outer wall according to the invention as a cross-sectional representation which comprises the first exemplary embodiment of the parcel chute according to the invention from FIGS. 1 and 2; and

FIG. 8 shows a second exemplary embodiment of an outer wall according to the invention as a cross-sectional representation which comprises the third exemplary embodiment of the parcel chute according to the invention from FIGS. 4 and 5.

### DETAILED DESCRIPTION

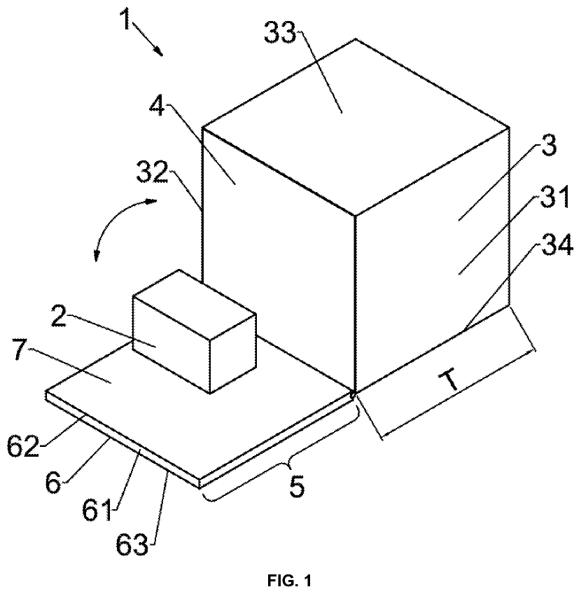

FIG. 1 shows a first exemplary embodiment of a parcel chute 1 according to the invention for an outer wall of a building or an enclosure of a balcony as a perspective representation from the front, which is used for the automatic delivery and collection of a parcel 2 by means of an unmanned aircraft, in particular a logistics drone. This parcel chute 1 comprises a base body 3 with an opening 4 for the parcel 2 and a first side 5 for the delivery or collection of the parcel 2. The base body 3 is designed as a rectangular frame which has two vertical legs 31, 32 arranged spaced apart from one another and two horizontal legs 33, 34 arranged spaced apart from one another. These vertical legs 31, 32 and horizontal legs 33, 34 enclose the opening 4. The frame 3 in the present exemplary embodiment is designed as an injection molded part made of plastic and has a frame depth T of 37 cm. This frame 3 is therefore suitable for installation in an outer wall of a building which has a wall thickness D of 37 cm. Furthermore, the first exemplary embodiment of the parcel chute 1 according to the invention comprises a chute door 6 which is movably arranged on the base body 3. In the present first exemplary embodiment, this chute door 6 is a pivotable flap which is arranged so as to be pivotable about an axis on a first horizontal leg 34 of the base body 3. This pivotable flap 6 closes the opening 4 substantially completely in the closed state and opens up the opening 4 in the opened state to guide the parcel through the opening 4. The parcel chute 1 further comprises a drive schematically depicted via the arrow in FIG. 1. This drive, which can be an actuator, interacts with the pivotable flap 6 in such a manner that it moves the pivotable flap 6 from the closed state into the opened state, and in the opposite direction, and therefore opens up the opening 4 for guiding parcels 2 through or closes it. In order to avoid a heat bridge in the region of the opening 4, the pivotable flap 6 has a layer structure with a core layer 61 made of heat-insulating material and two outer layers 62, 63 of high-grade steel delimiting the core layer 61 on one side each. The heat-insulating material in this first exemplary embodiment of the parcel chute 1 is a vacuum insulating panel which contains a silicate-based aerogel, from which the air has been removed by evacuation. Apart from the vacuum insulating panel, the core layer 61 also comprises the drive which is therefore likewise arranged between the outer layers 62, 63. The parcel chute 1 further comprises a parcel drop-off area 7 which is arranged on the first side 5 of the base body 3 in the opened state of the chute door 6 and on a side of the pivotable flap 6 facing the opening 4 in the closed state of the chute door 6. The parcel 2, which has been delivered by the unmanned aircraft, lies on this parcel drop-off area 7. Furthermore, the parcel chute 1 has a communication unit not shown in FIG. 1, which is designed to communicate contactlessly with the unmanned aircraft when the parcel 2 is delivered or collected. Apart from the vacuum insulating panel and the drive, the core layer 61 also comprises the communication unit which is therefore likewise arranged between the outer layers 62, 63.

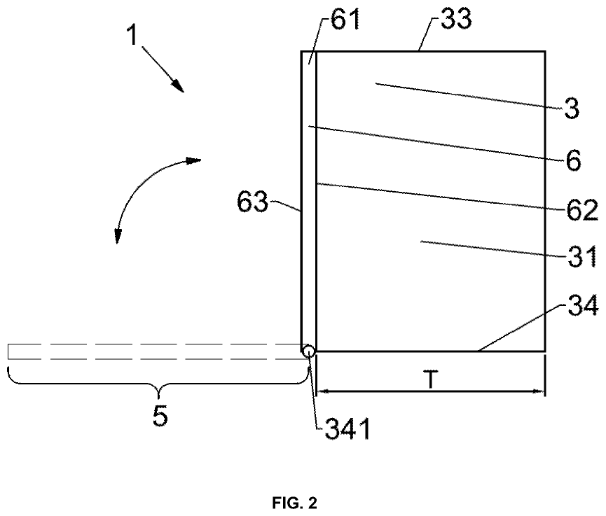

FIG. 2 shows the first exemplary embodiment of the parcel chute 1 from FIG. 1 in side view, wherein the chute door 6 is in its closed state and therefore completely closes the opening 4. As has already been mentioned beforehand, this chute door 6 is designed as a pivotable flap. This flap 6 is pivotable by 90° about an axis in the direction of the first side 5 of the base body 3 on the first horizontal leg 34, wherein it opens up the opening 4 by pivoting. The pivoting direction is indicated in FIG. 2 by the arrow contained therein and the opened state of the chute door 6 by the position of the flap 6 depicted by a dotted line. So that the flap 6 can be pivoted about the axis, the first horizontal leg 34 of the base body 3 has a hinge 341 which is arranged on a side of the first vertical leg 34 facing the first side 5 of the base body.

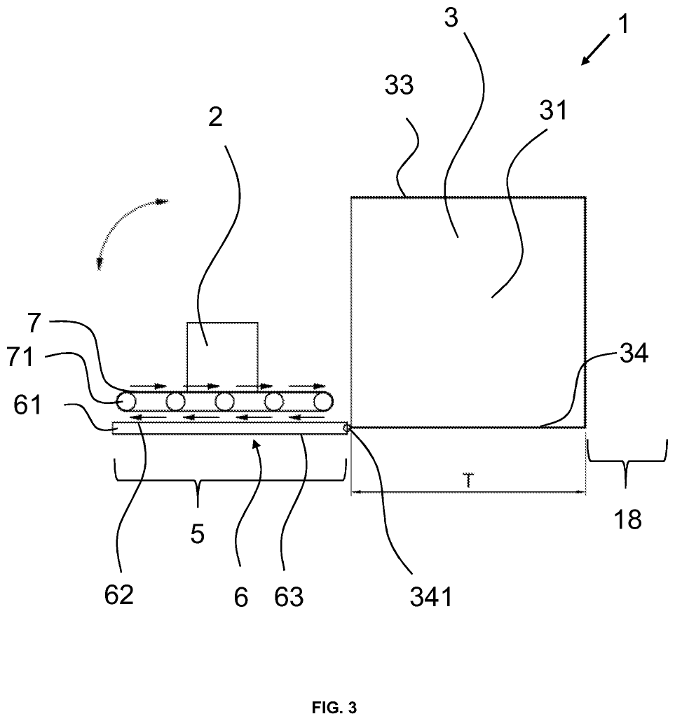

FIG. 3 shows a second exemplary embodiment of the parcel chute 1 according to the invention in side view. This second exemplary embodiment differs from the first exemplary embodiment shown in FIGS. 1 and 2, in that the parcel drop-off area 7 of the parcel chute 1 has a conveying element 71 in the form of a conveyor belt. This conveyor belt 71 is designed to convey the parcel 2 following its delivery from the first side 5 to the second side 18 of the base body (the movement direction is indicated by horizontal arrows in FIG. 3). When a parcel 2 is collected, the conveyor belt 71 can also convey the parcel 2 in the opposite direction, so from the second side 18 to the first side 5 of the base body 3.

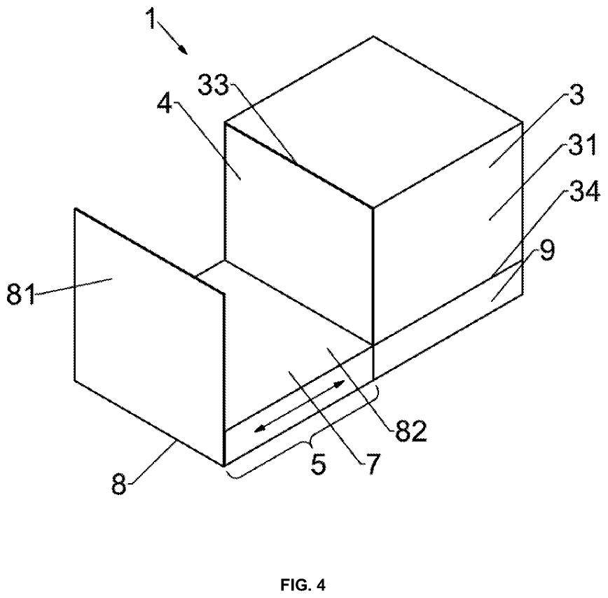

FIG. 4 shows a third exemplary embodiment of the parcel chute 1 according to the invention as a perspective representation from the front. This third exemplary embodiment differs from the first exemplary embodiment shown in FIGS. 1 and 2, in that the parcel chute 1 has a drawer 8 designed in one piece which can be extended it the direction of the first side 5 of the base body, wherein the parcel drop-off area 7 is arranged on a side of the drawer 8 facing the opening 4. The extension direction of the drawer 8 is indicated by the double arrow shown in FIG. 3. The chute door of this parcel chute 1 is a drawer end wall 81 of the drawer 8, which is arranged perpendicularly to a drawer base 82 of the drawer 8, wherein the drawer end wall 81 completely closes the opening 4 in the closed state of the chute door 81 not depicted in FIG. 3. For this purpose, the opening 4 and the drawer end wall 81 have the same dimension. This drawer end wall 83 also has the previously described layer structure, in order to avoid a heat bridge in the region of the opening 4. On a side of the first vertical leg 34 facing away from the opening 4, the parcel chute 1 has a drawer receiving element 9. In order to move the chute door or the drawer end wall 81 from the opened to the closed state, the drawer base 82, and therefore also the parcel drop-off area 7, is pushed into the drawer receiving element 9. In other words, the parcel drop-off area 7 is arranged on the first side 5 of the base body 3 only in the opened state of the chute door or the drawer end wall 81, and therefore not in the closed state of the chute door or of the drawer end wall 81 on the first side 5 of the base body 3.

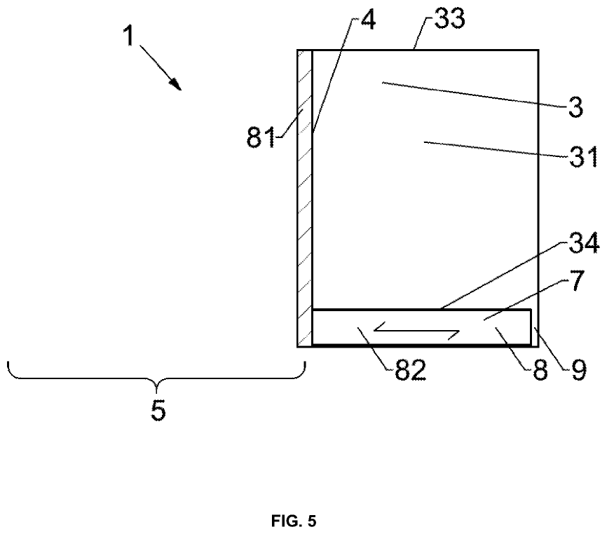

FIG. 5 shows the third exemplary embodiment of the parcel chute 1 according to the invention from FIG. 4 in side view, wherein the chute door 8 is in its closed state, so that the drawer end wall 83 completely closes the opening 4 and the drawer base 82 is inserted into the drawer receiving element 9.

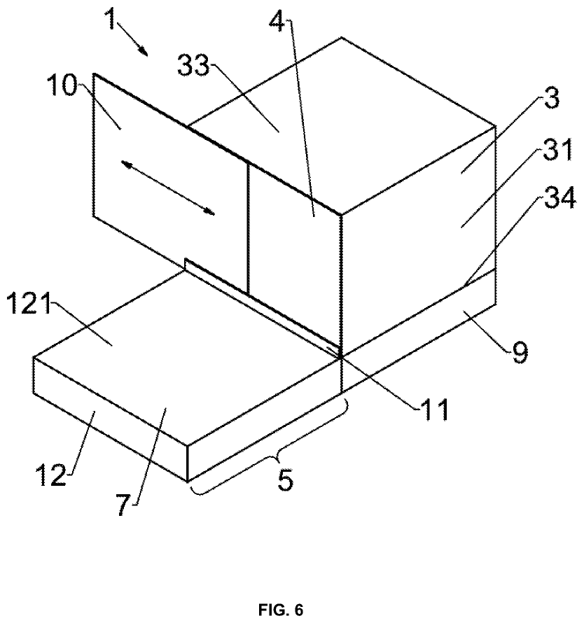

FIG. 6 shows a fourth exemplary embodiment of the parcel chute 1 according to the invention as a perspective representation from the front. This fourth exemplary embodiment differs from the third exemplary embodiment shown in FIGS. 4 and 5, in that the chute door is a one-piece sliding door 10 which can be slid in front of the opening 4 in order to move into the closed state. The directions in which the sliding door can be slid are indicated in FIG. 6 by a double arrow. Despite this sliding door 10, the parcel chute 1 also has a drawer 12. However, unlike the drawer 8 shown in FIGS. 3 and 4, this drawer 12 has no drawer end wall designed as a chute door, but only the drawer base 121. The parcel drop-off area 7 is arranged on the upper side of this drawer base 121. Furthermore, the first horizontal leg 34 of the base body 3 has a guide rail 11 along which the sliding door 10 can be slid to move said sliding door 10 into the closed state in front of the opening 4.

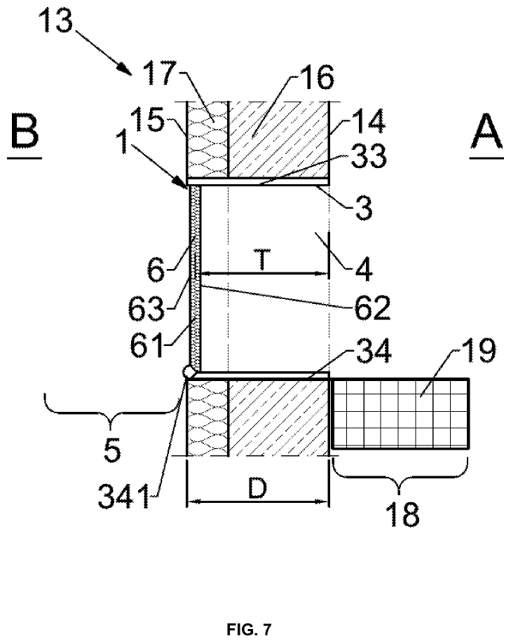

FIG. 7 shows a first exemplary embodiment of an outer wall 13 according to the invention as a cross-sectional representation which comprises the first exemplary embodiment of the parcel chute 1 according to the invention from FIGS. 1 and 2. This outer wall 13 further has a wall inner side 14 oriented towards a building inner side A, a wall outer side 15 oriented towards a building outer side B, a wall body 16 arranged in the region of the wall inner side 14 and a wall insulation 17 arranged in the region of the wall outer side 15. The parcel chute 1 in this case is integrated in the outer wall 13 in such a manner that its base body 3 crosses the outer wall 13 from the wall inner side 14 to the wall outer side 15, in other words, the wall body 16 and the wall insulation 17. The first exemplary embodiment of the parcel chute 1 has a receiving element in the form of a collection net 19 for the parcel 2 arranged on a second side 18 of the base body 3.

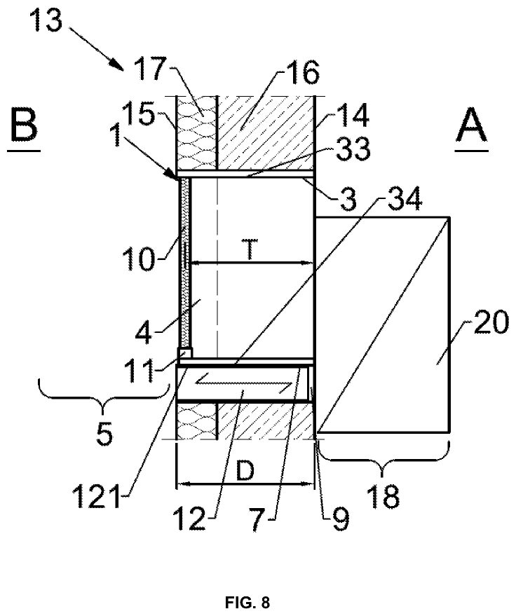

FIG. 8 shows a second exemplary embodiment of an outer wall 13 according to the invention as a cross-sectional representation. This second exemplary embodiment of the outer wall 13 differs from the first exemplary embodiment shown in FIG. 7, in that the second exemplary embodiment of the outer wall 13 comprises the fourth exemplary embodiment of the parcel chute 1 according to the invention from FIG. 6. The parcel chute in the form of the sliding door 10 is located in its closed state in FIG. 8, so that the opening 4 is closed. A further difference between the first and second exemplary embodiment of the outer wall 13 is that the receiving element for the parcel 2 in the second exemplary embodiment of the outer wall 13 is designed as a thermo-box 20.

1. A parcel chute (1) for an outer wall (13) of a building or an enclosure of a balcony which is used for automatic delivery and/or collection of a parcel (2) by an unmanned aircraft, the parcel chute comprising:
a base body (3) with at least one opening (4) for the parcel (2), a first side (5) for the delivery and/or collection of the parcel, and a second side (18) opposite the first side (5) for storing the parcel (2);
a chute door (6, 81, 10) which is movably arranged on the base body (3), the chute door (6, 81, 10) substantially completely closes the opening (4) in a closed state and opens the opening up in an opened state, in order to guide the parcel (2) through the opening (4);
a parcel drop-off area (7) arranged on the first side (5) of the base body (3), at least in the opened state of the chute door (6, 81, 10);
a drive configured to move the chute door (6, 81, 10) from the closed state into the opened state and in an opposite direction; and
a communication unit which is configured to communicate contactlessly with the unmanned aircraft during the delivery and/or collection of the parcel (2) and is connected to the drive in an information-conveying manner, as a result of which the chute door (6, 81, 10) is moveable from the closed state into the opened state, and in the opposite direction, during the delivery and/or collection of the parcel (2).

2. The parcel chute (1) according to claim 1, wherein the chute door (6, 81, 10) is formed at least partly from a heat-insulating material.

3. The parcel chute (1) according to claim 1, further comprising a receiving element (19, 20) for the parcel (2) arranged on the second side (18) of the base body (3), said receiving element comprising at least one of a collection net, a box, a thermo-box, or a refrigerator.

4. The parcel chute (1) according to claim 1, wherein the parcel drop-off area (7) has a conveying element (71) configured to transport the parcel (2) from the first side (5) to the second side (18) of the base body (3), or in the opposite direction.

5. The parcel chute (1) according to claim 1, wherein the parcel drop-off area (7) further comprises a charging device for electrical charging of rechargeable battery cells of the unmanned aircraft.

6. The parcel chute (1) according to claim 1, wherein the communication unit has at least one of a transmitter for positional data of the parcel chute or a receiver for receiving at least one of positional data of the unmanned aircraft or data relating to the parcel (2).

7. The parcel chute (1) according to claim 1, wherein the chute door (6, 81, 10) is arranged at least in the opened state on one of the first side (5) or the second side (18) of the base body (3).

8. The parcel chute (1) according to claim 1, wherein the base body (3) comprises a frame which has two vertical legs (31, 32) arranged spaced apart from one another and two horizontal legs (33, 34) arranged spaced apart from one another, and the vertical legs (31, 32) and the horizontal legs (33, 34) substantially enclose the opening (4).

9. The parcel chute (1) according to claim 1, wherein the chute door (6, 81, 10) comprises an at least one-piece sliding door (10), which is slidable for movement into the closed state in front of the opening (4).

10. The parcel chute (1) according to claim 9, wherein the base body (3) has at least one guide rail (11) along which the sliding door (10) is slidable to move the chute door (1) into the closed state in front of the opening (4), and the guide rail is arranged on a first horizontal leg (34) of the base body (3).

11. The parcel chute (1) according to claim 1, wherein the chute door (6, 81, 10) is a pivotable flap (6), which is arranged on the base body (3) so as to be pivotable about an axis, and the flap (6) is pivotable about 90° about the axis, in order to move the from the closed state into the opened state.

12. The parcel chute (1) according to claim 11, wherein the pivotable flap (6) is arranged on the base body (3) so as to be pivotable about the axis in a direction of the first side (5) of the base body, and when the pivotable flap (6) is in the closed state the parcel drop-off area (7) is arranged on a side of the pivotable flap (6) facing the opening (4).

13. The parcel chute (1) according to claim 1, further comprising a drawer (12, 8) formed in at least one piece, which is extendible in a direction of the first side (5) of the base body (3), and the parcel drop-off area (7) is arranged on a side of the drawer (12, 8) facing the opening (4).

14. The parcel chute (1) according to claim 13, further comprising a drawer base (121, 82) for the drawer (12) configured such that the drawer (12, 8) is extendible telescopically in the direction of the first side (5) of the base body (3).

15. The parcel chute (1) according to claim 13, wherein the chute door (6, 81, 10) is a drawer end wall (81) of the drawer (8) which is arranged substantially perpendicularly to a drawer base (82) of the drawer, and the drawer end wall (81) substantially completely closes the opening in the closed state of the drawer end wall (81).

16. The parcel chute (1) according to claim 1, wherein the chute door (6, 81, 10) comprises a layer structure with at least one core layer (61) formed at least partly from the heat-insulating material, and at least two outer layers (62, 63) respectively delimiting the core layer (61) on each side, and the core layer (61) further comprises at least one of the drive or the communication unit.

17. A method for delivering a parcel (2) using an unmanned aircraft and for guiding the parcel (2) through the parcel chute (1) according to claim 1, the method comprising the following steps:
a) flying the unmanned aircraft which is loaded with the parcel (2) in an incoming flight,
b) transmitting of a delivery instruction to the communication unit of the parcel chute (1),
c) transmitting of positional data of the parcel chute (1) by the communication unit to the unmanned aircraft,
d) moving of the chute door (6, 81, 10) of the parcel chute from the closed state into the opened state by the drive of the parcel chute (1), resulting in the opening (4) in the base body (3) of the parcel chute (1) being opened up to guide the parcel (2) through the opening (4),
e) setting of a course by the unmanned aircraft for a parcel drop-off area (7) of the parcel chute (1) arranged on the first side (5) of the base body (3) with using the positional data transmitted,
f) dropping-off of the parcel (2) on the parcel drop-off area (7) by the unmanned aircraft,
g) guiding the parcel (2) from the first side (5) of the base body (3) through the opening (4) to the second side (18) of the base body (3),
h) moving the chute door (6, 81, 10) of the parcel chute (1) from the opened state into the closed state by the drive of the parcel chute (1), as a result of which the opening (4) in the base body (3) of the parcel chute (1) is closed.

18. The method according to claim 17, further comprising receiving the parcel (2) by a parcel receiving element (19, 20) of the parcel chute (1) arranged on the second side (18) of the base body (3) following method step (g), said parcel receiving element comprising at least one of a collection net, a box, a thermo-box, or a refrigerator.

19. The method according to claim 17, wherein the parcel (2) is transported in method step (g) by a conveying element (71) from the first side (5) of the base body (3) through the opening (4) to the second side (18) of the base body (3).

20. The method according to claim 17, further comprising electrically charging rechargeable battery cells of the unmanned aircraft during, or after, method step (f) by a charging device of the parcel drop-off area (7).

21. An outer wall (13) of a building comprising a wall inner side (A) oriented to a building inner side, a wall outer side (B) oriented to a building outer side, a wall body (16), wall insulation (17), and the parcel chute (1) according to claim 1, wherein the base body (3) with the at least one opening (4) of the parcel chute (1) crosses the outer wall (13) from the wall inner side (A) to the wall outer side (B).

22. An enclosure for a balcony of a building, comprising at least one vertically standing enclosure element, an enclosure inner side of the enclosure element facing a building side, an enclosure outer side of the enclosure element opposite the enclosure inner side, and the parcel chute (1) according to claim 1, wherein the base body with the at least one opening in the parcel chute crosses the vertically standing enclosure element from the enclosure outer side to the enclosure inner side.
